(19) United States
(12) Patent Application Publication
(10) Pub. No.: US 2022/0258493 A1
(43) Pub. Date: Aug. 18, 2022

(54) MARKING OF CERAMIC BODIES

(71) Applicant: CORNING INCORPORATED, CORNING, NY (US)

(72) Inventors: Alexandre Mikhailovich Bratkovski, CORNING, NY (US); Kathy Margaret Corcoran, CORNING, NY (US); Mariia Andreevna Lapina, St. Petersburg (RU); Nadezhda Pavlovna Paramonova, Saint-Petersburg (RU)

(21) Appl. No.: 17/617,176

(22) PCT Filed: Jun. 28, 2019
(86) PCT No.: PCT/RU2019/000467

§ 371 Date: Dec. 7, 2021

(51) Int. Cl. B41J 3/407; C04B 41/45; C04B 41/49; C09D 11/322; B41M 5/00

(52) U.S. Cl. CPC B41J 3/4073; C04B 41/4578; B41J 2202/02; C09D 11/322; B41M 5/0088; C04B 41/4961

(57) ABSTRACT

An inkjet printhead, a system including an inject printhead, and a method for applying primer to a target area on an outer surface of a ceramic body. The inkjet printhead comprises an ink chamber comprising the primer therein. The primer comprises a pigment, a binder, and a solvent. The primer also comprises a surface tension of at least about 40 mN/m. A spray nozzle is connected to the ink chamber and comprises an exit opening that comprises an area of less than about 20,000 square microns. The spray nozzle is configured to eject droplets of the primer from the exit opening at an average exit velocity of less than about 4 m/s.

### BACKGROUND OF THE INVENTION

The marking of ceramic bodies such as the honeycomb bodies of ceramic particulate filters and catalytic converter substrates used in vehicular engine exhaust treatment systems presents various challenges. Such marking can include forming a mark or label onto the honeycomb body, for example conveying part-identifying information, a machine-readable code, and the like.

### BRIEF SUMMARY OF THE INVENTION

In one aspect, an inkjet printhead for applying primer to a target area on an outer surface of a ceramic body is provided. The inkjet printhead comprises an ink chamber comprising the primer therein, the primer comprising a pigment, a binder, and a solvent, and comprising a surface tension of at least about 40 mN/m; and a spray nozzle connected to the ink chamber, the spray nozzle comprising an exit opening that comprises an area of less than about 20,000 square microns, the spray nozzle configured to eject droplets of the primer from the exit opening at an average exit velocity of less than about 4 m/s.

In some embodiments, the pressure of the inkjet chamber is less than about 0.5 bar. In some embodiments, the pressure of the inkjet chamber is less than about 0.4 bar. In some embodiments, the area of the exit opening of the spray nozzle is less than about 10,000 square microns. In some embodiments, the exit area is circular or slot shaped.

In some embodiments, the primer comprises a TiO₂ pigment, a binder, and a solvent. In some embodiments, the primer has a surface tension of at least about 50 mN/m. In some embodiments, the solvent comprises at least about 50 wt % pentyl propionate.

In one aspect, a system comprises an inkjet printhead according to one of the embodiments disclosed herein. In some embodiments, the system further comprising a conveyor configured to move the ceramic body relative to the inkjet printhead. In some embodiments, the ceramic body is a fired ceramic body. In some embodiments, the ceramic bod, is a green body.

In another aspect, a method of marking an outer skin of a ceramic body is provided. The method comprises ejecting primer from an ink chamber of an inkjet printhead via an exit opening of a nozzle at an exit velocity of less than about 4 m/s; and forming a layer of primer in a target area on an outer surface of the ceramic body by spraying primer from an ink chamber and through an exit opening of a nozzle of an inkjet printhead at an exit velocity of less than about 4 m/s, wherein the primer has a surface tension of at least about 40 mN/m when ejected from the nozzle.

In some embodiments, the pressure of the inkjet chamber is less than about 0.5 bar. In some embodiments, the pressure of the ink chamber is less than about 0.4 bar. In some embodiments, the exit area of the spray nozzle is less than about 20,000 square microns. In some embodiments, the exit opening is circular or slot shaped.

In some embodiments, the primer comprises a TiO₂ pigment, silicone resins, and a solvent. In some embodiments, the solvent comprises at least about 50 wt % pentyl propionate. In some embodiments, the method additionally comprises laser marking a code on the primer layer.

### BRIEF DESCRIPTION OF THE FIGURES

The accompanying drawings are included to provide a further understanding of the disclosed embodiments and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1A illustrates an inkjet printhead during operation.

FIG. 1B illustrates an inkjet printhead according to one embodiment disclosed herein during operation.

FIG. 2 is a schematic view illustrating the spraying of primer onto a ceramic body.

FIG. 3 shows an array of sprayed primer droplets airborne and traveling toward a ceramic body.

FIG. 4 shows an Ohnesorge-Reynolds map of showing various regions of inkjet printing behavior.

FIG. 5 shows the primer velocity distributions resulting from experiments with an inkjet printhead having an ink chamber pressure of 0.7 bar in comparison to an ink chamber pressure of 0.3 bar.

FIG. 6 shows the primer droplet size distributions resulting from experiments with an inkjet printhead having an ink chamber pressure of 0.7 bar in comparison to an ink chamber pressure of 0.3 bar.

FIG. 7 shows a scatter plot for momentum and droplet size corresponding to the experiments of FIGS. 5 and 6.

FIG. 8 shows a scatter plot for velocity and droplet size corresponding to the experiments of FIGS. 5 and 6.

FIG. 9 shows a series of snapshots showing a train of ejected primer droplets (a, b) and the splashing of the head group of primer droplets on a ceramic body over time (b, c, d, e, f).

FIG. 10 shows a splashing of a train of primer droplets on a ceramic body.

FIG. 11 shows splashing of jetted primer on a ceramic body having about 30% porosity.

FIG. 12 shows splashing of jetted primer on a ceramic body having about 60% porosity.

### DETAILED DESCRIPTION

The embodiments set forth below represent the information useful to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

As disclosed herein, the marking of a ceramic honeycomb body comprises the use of an inkjet printhead to spray an ink, e.g., a primer ink or simply primer, to create the background for a mark to be printed on the outer skin of the ceramic honeycomb body. For example, the primer may be a white or light color onto which a code of contrasting color can be applied, e.g., by laser marking. In some embodiments, a target spray area on the ceramic honeycomb body is an area of about 4 square inches such as a square of about 2 inches by 2 inches, although other shapes and sizes can be utilized. Overspray of the primer during inkjet printing may result in a significant amount of wasted material and a decrease in print quality. For example, overspray includes excess ink that does not contribute to printing in the target spray area, such as ink that is broken up into small droplets (e.g., by Plateau-Rayleigh instability, air resistance, etc.) during spraying and do not land in the spray area. For example, these small droplets may form a mist or fog of droplets suspended in air. These small droplets may also be deflected, e.g., by air resistance, such that they land on the honeycomb body outside of the target spray area. Overspray may also result from droplets that splash or bounce off the surface of the ceramic honeycomb body. The droplets resulting from splashing or bouncing may ultimate land on the surface of the honeycomb body outside of the target spray area and/or contribute to small droplets that become suspended in air as mist or fog. Accordingly, there is a need for inkjet printheads and processes that reduce or eliminate primer overspray.

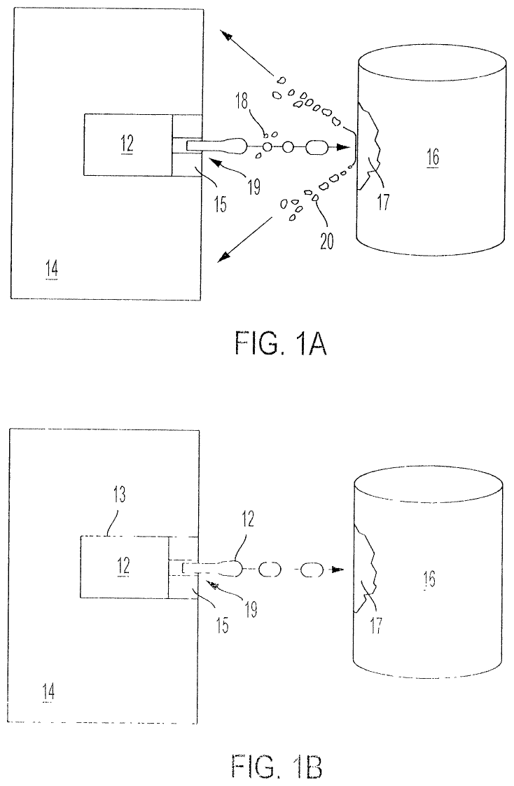

FIG. 1A illustrates one example of an inkjet printhead during operation. A primer mixture, designated as primer 12, is sprayed from an inkjet printhead 14 toward a ceramic body 16 (e.g., a ceramic honeycomb body upon which the primer ink is applied). The inkjet printhead 14 comprises an ink chamber 13 for holding a supply of the primer 12 and that is in fluid communication with a spray nozzle 15 comprising one or more exit openings 19 from which the primer is dispensed. The inkjet printhead 14 sprays a jet, e.g., a conical jet, of numerous primer droplets.

The size of the droplets depends at least in part on the size (e.g., diameter) of the exit openings of the nozzles 15 of the printhead 14, the pressure in the ink chamber 13, and the exit velocity of the droplets from the nozzles 15 of the printhead 14. In some embodiments, the exit area of the nozzles 15 is less than about 20,000 square microns (micrometers). In some embodiments, the exit area of the spray nozzle is less than about 10,000 square microns. The shape of the exit area of the spray nozzle is preferably circular or slot shaped. The average exit velocity of droplets from the nozzle 15 is preferably less than about 4 m/s. In some embodiments, suitable exit velocities are achieved when a pressure of the inkjet chamber is preferably less than about 0.5 bar and more preferably about 0.3 bar.

The size of the droplets may also depend on an operational frequency of an actuating element of the printhead 14. For example, the printhead 14 can be a dot on demand (DoD) printhead employing an actuating element such as a thermal or piezoelectric element that causes droplets of primer to be dispensed from the nozzle 15 at a regular frequency, e.g., in response to a series of electrical pulses to the actuating element. For example, during operation, a piezoelectric or thermal element, e.g., positioned generally opposite to the exit opening of the print nozzle, is supplied with pulses of electrical current, e.g., at a set frequency. The frequency can be described by a cycle time, e.g., the time between each actuation of the actuating element. Each pulse of electrical current causes the actuating element to force ink out of the exit opening (e.g., by a piezoelectric element mechanically pushing the primer out of the nozzle opening, or a thermal element rapidly heating the primer to cause it to at least partially boil and jet from the nozzle opening). Thus, in addition to the pressure in the chamber 13 and the diameter of the exit opening of the nozzle 15, the amount of ink that is ejected during each pulse, and thus the droplet size, is also a function an operating frequency or cycle time, of an actuating element, such as a piezoelectric element.

The jet of primer 12 breaks up into smaller secondary droplets, identified generally as secondary droplets 18, while airborne traveling from the printhead 14 to a target area 17 on the body 16. The secondary droplets 18 generally become suspended in air or otherwise deflected by air resistance such that they contribute to the generation of a mist or fog of the primer in the air surrounding the ceramic body 16. The target area 17 can take a desired or designated shape, such as a rectangle or square on which a subsequent mark or code is formed, e.g., by laser marking. The primer 12 will break up into droplets of different sizes according to various hydrodynamic mechanisms, such as due to Rayleigh-Plateau instability, wind or air-induced breakup (from air resistance as the liquid is airborne traveling to the body 16), etc. Atomization occurs when the jet disintegrates into extremely small droplets, such as at extremely high spray velocities.

The size of the droplets of primer can contribute to overspray. For example, as the droplet size decreases, air resistance more readily influences the airborne behavior of the droplets, e.g., to deflect or redirect the small droplets away from the target area 17, whereas larger droplets more readily travel directly to the target area 17 without being moved off-course by wind resistance. Sufficiently small droplets will be effectively suspended in air, forming a mist or fog instead of landing in the target area 17. Thus, as used herein, the secondary droplets 18 are those that break up into such a small size that they cannot effectively travel to the surface of the body 16, e.g., due to the effects of air resistance. Additionally, splash 20 may occur when droplets hit the surface of the body 16, further contributing to overspray of ink due to primer 12 rebounding off the body 16 even if the droplet initially lands within the target area 17. In comparison, FIG. 1B illustrates a scenario in which a relatively consistent droplet size is maintained in a jet of the primer 12 (e.g., the jet does not break up into small droplets or atomize) and which does not cause excessive splashing 20 at the surface of the ceramic body, thereby reducing or eliminating overspray.

Ceramic honeycomb bodies or articles as described herein include a matrix of intersecting walls forming channels that extend between opposite end faces, which matrix of intersecting walls is surrounded by a skin. The skin forms the outer surface upon which the primer is applied as described herein. Some of the channels of some honeycomb bodies may be plugged, e.g., particularly in the case of particulate filters, or may be left open, e.g., particularly in the case of catalytic converter substrates. Examples of ceramic batch material compositions for forming ceramic articles that can be used in practicing the presently disclosed embodiments are disclosed in commonly assigned U.S. Pat. Nos. 3,885,977; 4,950,628; 5,183,608; 5,258,150; 6,210,626; 6,368,992; 6,432,856; 6,506,336; 6,773,657; 6,864,198; 7,141,089; and 7,179,316, all of which are incorporated herein by reference in their entireties. Ceramic bodies can be formed, for example, from inorganic materials including clay, silica, alumina, and magnesia that can be supplied in the form of talc, kaolin, aluminum oxide, and amorphous silica powders, in addition to other materials. Alternatively and/or additionally to cordierite, honeycomb bodies can be formed at least in part from other ceramic materials, such as aluminum titanate, mullite, silicon carbide, etc.

The data carrying mark applied to the primer layer can comprise identifying information, such as a machine-readable code or component. Examples of such codes include one-dimensional bar codes (information conveyed via a series of different widths arranged in a one-dimensional line), two-dimensional matrix codes (e.g., array of dark and light-colored squares or boxes), etc. Machine-readable components can include a pattern of printed (e.g., relatively darkly colored) dots or other portions and unprinted (e.g., relatively lightly colored) portions. The use of different colors for the printed and unprinted portions can be used to increase the optical contrast between the printed and unprinted portions, for example to reduce the chance of a reading error. The machine-readable code can comprise any suitable type of information carrying pattern of marked and unmarked portions. In addition to machine-readable components, a mark can also include a human-readable component, e.g., an alpha-numeric data string, to facilitate extraction of the data when a computerized code reader is not available.

The data carrying mark can contain specific manufacturing information, such as the specific factory and/or kiln that produced the fired ceramic body, the batch, the production date and time, and/or a unique individual identification code (e.g., using a globally unique identifier system or other coding system in which no two codes are alike for some significant period of time). The unique individual identification code can contain the station, production line, and/or facility that provided the mark, the date, a sequential number of the tired ceramic body produced on that date, etc. It is also possible for the unique identifier to be further encrypted by a suitable encryption code to make it difficult for the coded information to be reverse engineered except by the manufacturer who of course holds the key to the encryption code.

Data for each unique individual identifier assigned and relating to an individual honeycomb can be stored in a relational database during the manufacturing sequence and can be extracted at a later time. As such, the origin, manufacturing materials and processes used, and equipment and apparatus used to manufacture the honeycomb body, as well as performance, properties, and attributes of the honeycomb body can be readily looked up after manufacture. Accordingly, any defect or variation in the honeycomb body can be readily related to the materials, processes, and/or equipment used. Thus, if desired, changes can be made in the raw materials, processes, etc. to effect changes in properties or attributes and to reduce the occurrence of such defects in future honeycomb articles.

The unique identifier information can be generated by a computer program that ensures that the code is unique to each individual honeycomb for a significant period of time, for example, greater than a decade. This allows for traceability of that particular honeycomb to any process that it underwent during its manufacture, including traceability to the raw materials used, the specific batches and processes employed, the date of manufacture, specific extruder lines and extrusion dies used, kilns and firing cycles, finishing operations employed, etc.

According to methods disclosed herein, the data carrying mark or code is applied to a white primer layer using a laser to oxidize the primer solids and fuse them onto the surface of the ceramic body. In one embodiment, the laser is a carbon dioxide laser. The laser marking can be performed immediately following application of the primer layer without any intermediate drying or curing step. After the laser marking, the ceramic body can be heated to between 350°-500° C. to calcine the primer layer.

The primer in embodiments disclosed herein contains a pigment, a binder, a thickener, and a solvent. To facilitate readability, or legibility, the primer layer can be high contrast with respect to a mark, pattern, and/or code created on the primer layer (e.g., a machine-readable pattern such as a bar code or matrix code). In some embodiments, the primer is white or lightly colored so that dark-colored marking patterns readily appear on it (e.g., the marking patterns applied by dark or black ink, laser burning, etc.). In some embodiments. TiO₂ is used as a white pigment. In some embodiments, the hinder comprises a resin such as a silicone resin that assists in holding the pigment together, particularly after evaporation of the solvent. Other ingredients such as a dispersing agent or surfactant can be included to prevent coagulation of other components of the primer mixture. Thickeners, such as fumed silica, can also be included. The primer can comprise between about 25-55 wt % pigment, 15-30 wt % solvent, and 15-45 wt % binder, with less than about 2 wt % other ingredients such as surfactants or thickeners.

The solvent carries the pigment and assists in application of the primer layer on a ceramic body. The solvent can be selected as a volatile or quickly drying material. In some embodiments, as discussed in more detail herein, the primer has a surface tension (e.g., set at least in part by the solvent) of preferably at least about 40 mN/m and more preferably at least about 50 mN/m, which reduces splashing or bouncing of droplets off the surface of the body and helps to reduce shearing of the droplets into a mist or fog during airborne travel to the ceramic body, thereby reducing overspray. In some embodiments, the primer has a viscosity μ at room temperature (e.g., approximately 20-22° C.) of at least about 2.0 mPa·s. In some embodiments, the primer composition comprises up to 25 wt % solvent. In some embodiments, the solvent primarily comprises pentyl propionate, i.e., at least 50 wt % of the solvent is pentyl propionate, in order to achieve a suitable surface tension when combined with the other components of the primer (e.g., a pigment and a resin). The solvent can comprise additional materials such as butanol and amyl acetate. As the solvent in the primer dries, a layer of pigment (e.g., TiO₂) particles is left behind on the ceramic body (e.g., bound by a binder such as a resin), thereby providing a sprayed patch with the desired color (e.g., a white color if TiO₂ is used as a pigment).

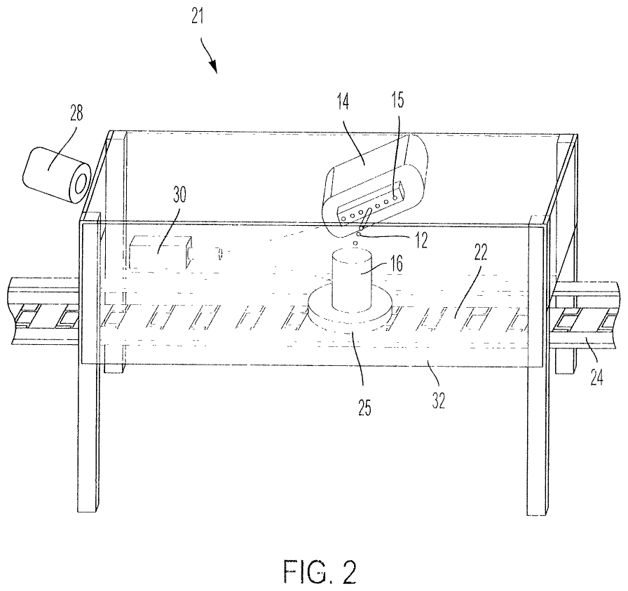

FIG. 2 is a schematic of a spraying system 21 for spraying of primer onto a ceramic body. A belt 22 on rail 24 supports a body 16. The printhead 14 sprays primer on body 16 as the body 16 is moved past the printhead 14. The system 21 can have other configurations that results in relative movement between the printhead 14 and the body 16. In some embodiments, the body 16 is stationary and the printhead 14 moves past and/or at least partially rotates around the body 16 to apply the primer. In some embodiments, a platform 25 upon which the body 16 is position is configured to rotate to facilitate more even coverage on the curved surface of the body 16 as the ceramic body passes by the printhead 14. In some embodiments, a rotary conveyor is used instead of a linear or straight belt.

### EXPERIMENTS

To further illustrate embodiments described herein, the following Experiments were conducted by the current inventors and are offered to illustrate specific articles and methods for producing the same. The following examples and experiments are for purposes of description only and are not intended to limit the scope of the claimed subject matter.

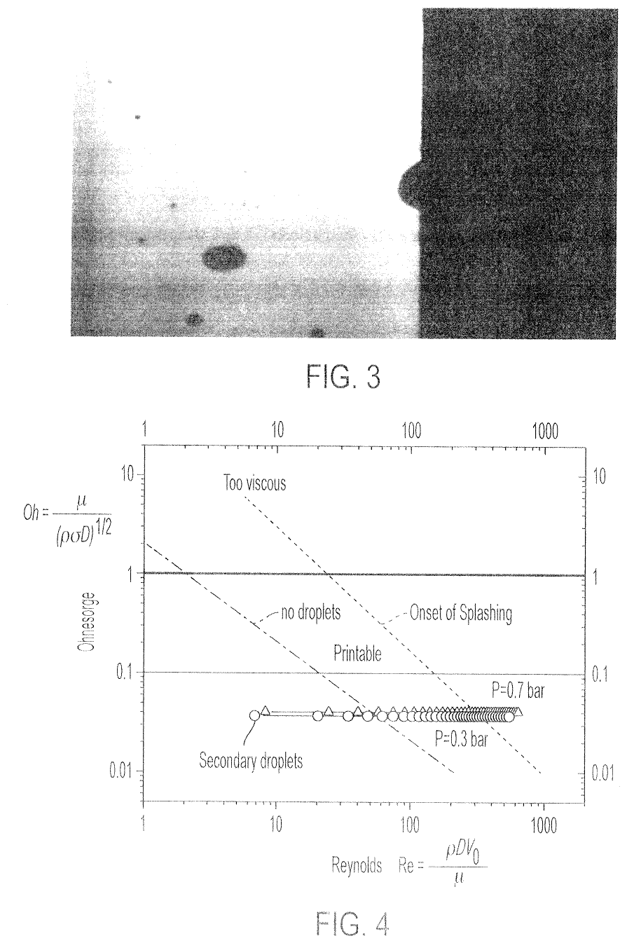

Referring to FIG. 2, for the purposes of conducting the Experiments, the system 21 further comprises a lamp 28 and camera 30 to respectively illuminate the ceramic bodies and photograph the spraying process. High-speed images corresponding to the conducted Experiments are shown in FIGS. 3 and 9-12. A transparent housing 32 was also be included that enabled naked eye viewing during the spraying process. During performance of the Experiments, only one nozzle of the printhead was configured to eject ink. The printhead used in the Experiments was a piezoelectric dot on demand (DoD) printhead.

Unless otherwise specified in the Experiments, the primer used comprised TiO₂ as a pigment and used methyl ethyl ketone as a solvent. The resulting primer had a surface tension of about 25.8 mN/m and viscosity of about 2.55 mPa·s. In comparison, methyl ethyl ketone alone (without the other ingredients) has a surface tension of about 17 mN/m and a viscosity of about 0.43 mPa·s.

### Experiment 1

FIG. 3 shows an array of sprayed primer droplets traveling through the air from a printhead toward the ceramic body. The ceramic body (e.g., the body 16) is the black field on the right of FIG. 3. A large variation in droplet sizes is seen, with some droplets several orders of magnitude smaller than others (e.g., and thus, potentially contributing to overspray as discussed above). The ink chamber pressure was 0.7 bar. The cycle time was about 1.3 milliseconds.

### Experiment 2

The dynamics of ink-jetting for part marking can be described by three dimensionless parameters: Reynolds (Re), Weber (We), and Ohnesorge (Oh) numbers. We equals ρDV²/σ, Re equals ρDV/μ, and Oh equals the square root of We divided by Re where ρ, μ, and σ denote liquid density, viscosity, and surface tension, and D and V denote the drop diameter and impact velocity, respectively. Generally, the Weber number is the ratio of kinetic and surface energy of the fluid, and the Reynolds number is the ratio of kinetic/convection energy to viscous loss of energy. The Ohnesorge number describes the relative role of viscosity versus a product of fluid surface tension and density.

The value of the Ohnesorge number is closely related to the behavior of a jet emerging from a nozzle. If the Ohnesorge number is too high (Oh≥1), then viscous forces will prevent the ejection of a primer drop, while if it is too low (Oh≤0.1), the primer jet will form a large number of secondary droplets, i.e., droplets that are prevented from reaching the intended area on surface of the ceramic body, e.g., due to the effects of air resistance on the small size of the droplets, such as the secondary droplets 18. FIG. 4 maps different regimes of printing with respect to Reynolds and Ohnesorge numbers. The spray jet must possess enough kinetic energy to be ejected from the nozzle leading to the line having a dash-dot pattern (—-—-—) in FIG. 4 corresponding to Re 2/Oh. It is also desirable to avoid splashing of the primer drop in impact with the ceramic body leading to the line having a dashed pattern (- - - - -) in FIG. 4 corresponding to OhRe^{5/4}=50. With the ink chamber pressure of 0.7 bar, secondary droplets of the primer and splashing occur. As shown in FIG. 4, reducing the pressure of 0.7 bar in the ink pressure to 0.3 bar reduces the amount of splashing and thus overspray.

### Experiment 3

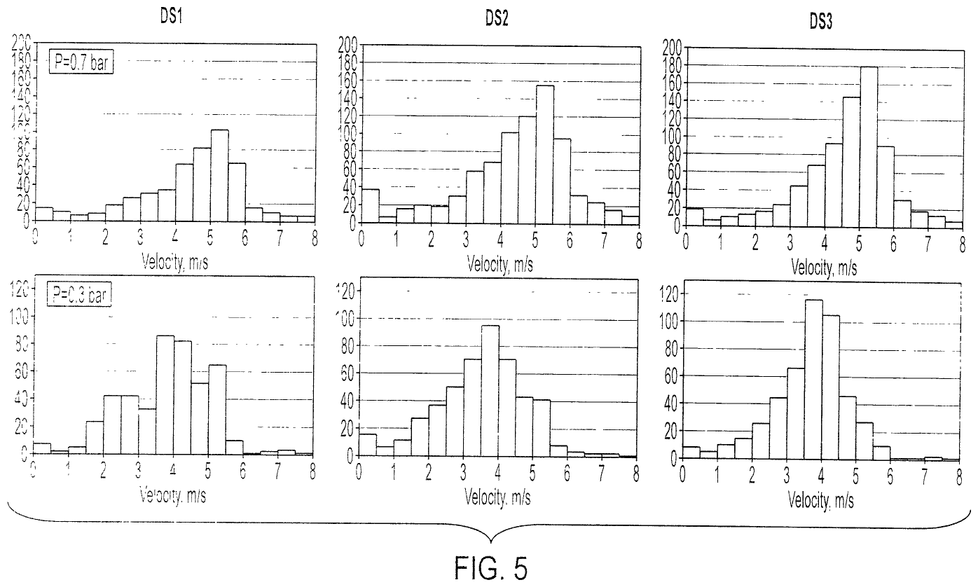

Primer velocity distributions were measured with a printhead having a nozzle with a 180 um diameter exit opening, with two distinct pressure settings in the ink chamber, P=0.7 bar (top row) and P=0.3 bar (bottom row) and for three different amounts of ink ejected during each pulse, which may be referred to as a “droplet size”, and designated herein as DS1, DS2, DS3 as shown in FIG. 5. DS1, DS2, and DS3 correspond to cycle times for the piezoelectric element of 1.01 ms, 1.32 ms, and 1.63 ms, respectively.

All cases show similar distribution of primer drop velocities as the ink travels towards the ceramic body. The distributions are non-normal and skewed towards smaller velocities. At P=0.7 bar, the distribution falls off sharply at about V=5.5 m/s, but with a considerable number of drops still exiting at a velocity V=8 m/s. As appreciable from the Ohnesorge-Reynolds map of FIG. 4, these velocities are very high and they will result in the generation of many secondary droplets, particularly droplets that become suspended in air or otherwise contribute to the formation of a mist or fog in the surrounding area.

To mitigate the problem with overspray in the 0.7 bar examples, pressure in the exit chamber was reduced down to P=0.3 bar. The distribution of the velocities shifted to smaller values as shown in the bottom panels of FIG. 5. The peak (mode) of the distribution moved to about V=4 m/s down from V=5.5 m/s in the P=0.7 bar results. Correspondingly, this resulted in a drop of average velocity from at least about 5.5 m/s range down to less than about 4.5 m/s. This reduction in velocities helped to reduce the splashing substantially.

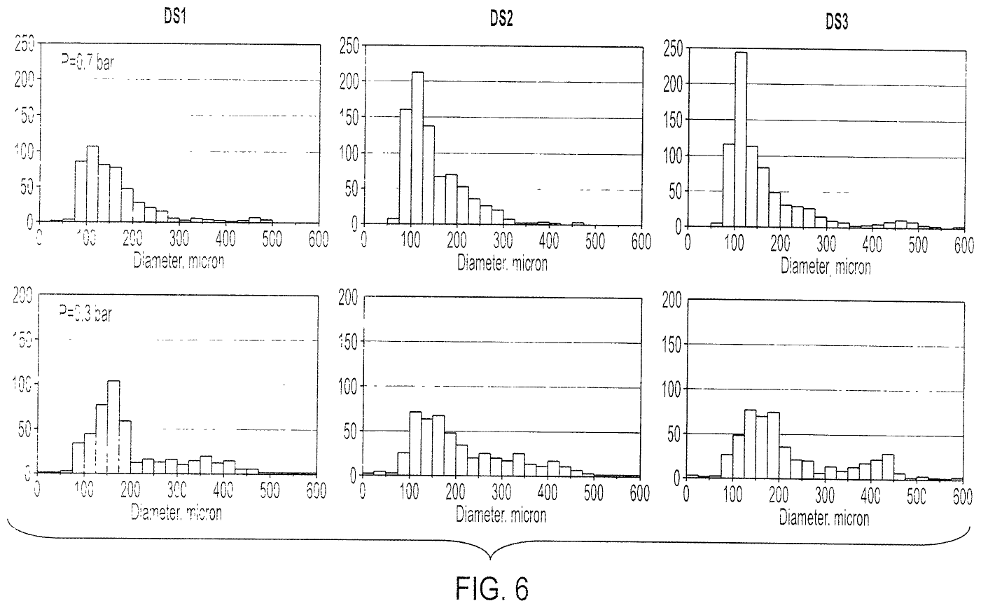

The droplet size distribution was also measured at an ink chamber pressure of P=0.7 bar (top row) and P=0.3 bar (bottom row) for the same three droplet sizes DS1, DS2, DS3 as shown in FIG. 6. While using the nozzle with a 180 um exit opening diameter, at pressure P=0.7 bar, the jet broke into small primer droplets such that the peak of the distribution was at about 100 urn (as opposed to the nozzle opening diameter of 180 um). In comparison, dropping the pressure to P=0.3 bar resulted in production of more droplets at or around the nominal diameter of 180 um. However, a secondary peak also developed at double that diameter size, i.e., at around 400 um. The second peak is believed to correspond to double droplets, i.e., two droplets combined together. As a result of these effects, the distribution for P=0.3 skewed towards large diameter drops. To alleviate the effects of the double droplets (e.g., increased splashing due to larger size), the dimensions of the nozzle opening can be set such that any double-droplets that are formed are within the 200-300 micron diameter range (thus producing normal droplets at around 100-150 microns). For example, in some embodiments, the exit area of the nozzles 15 is less than about 20,000 square microns, or even less than about 10,000 square microns.

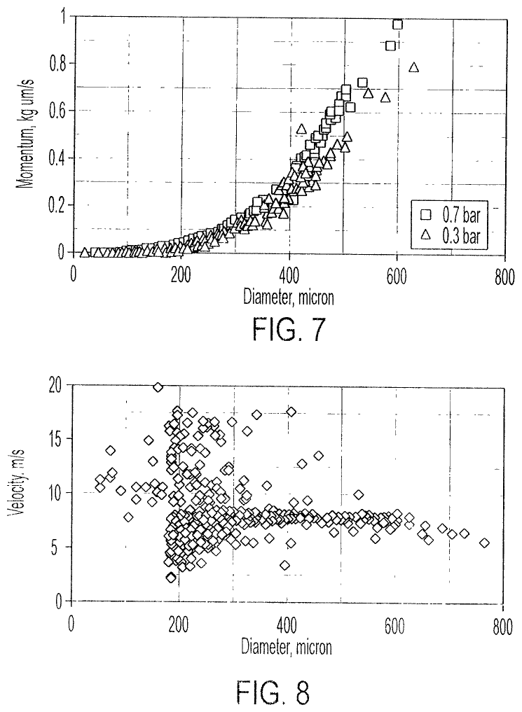

For both the pressure set at P=0.7 bar and P=0.3 bar, FIG. 7 shows a scatter plot of momentum and droplet diameter, while FIG. 8 shows a scatter plot of velocity and droplet diameter.

### Experiment 4

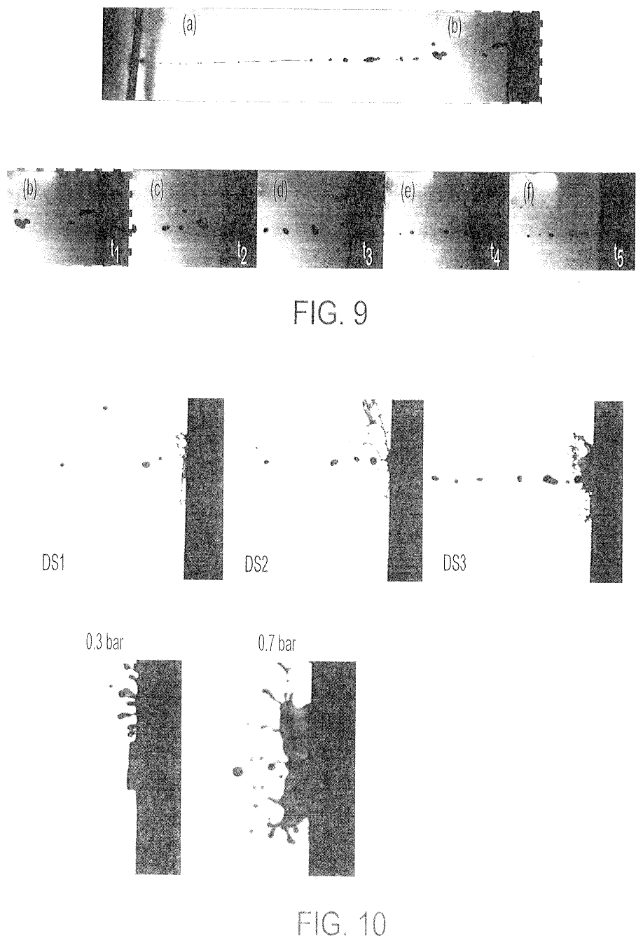

FIG. 9 shows in the images labeled (a)-(f), a train of primer droplets being ejected from a printhead with the head group, or leading group, of relatively larger and irregular droplets crashing on top of each other. Once there is a fluid film on the surface, the trailing drops produce vigorous splashing and mist near the part that contributes to overspray, e.g., is rebounded off the part and/or otherwise does not land within the target area to be printed.

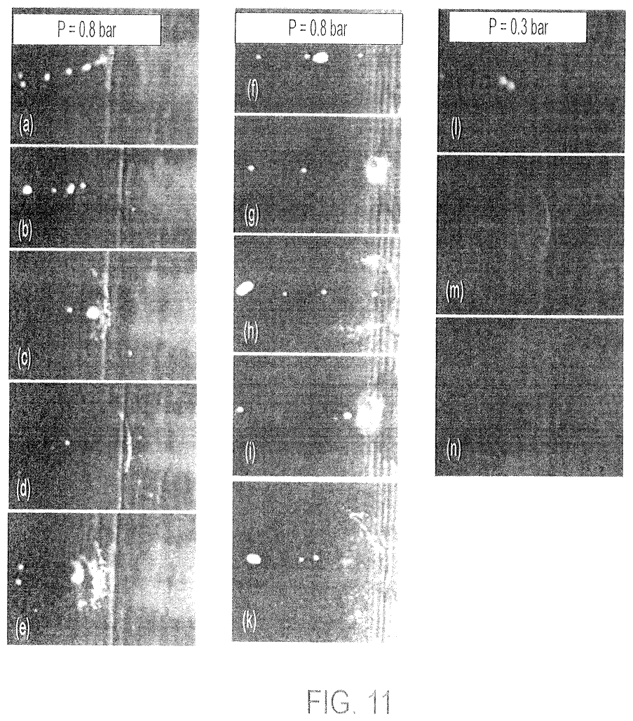

To gain insight into parameters affecting splashing, combinations of different droplet sizes (DS1, DS2, and DS3) and chamber pressures were compared, as shown in FIG. 10. A systematic increase in droplet size (again, corresponding to the average size of the droplets formed and/or the amount of ink ejected from the print during each electrical pulse to the actuating element of a DoD printhead), and the size of the resulting splash when the droplets hit the ceramic body is shown. In general, the greater pressure and increased droplet size resulted in a greater degree of splashing. Reducing chamber pressure from P=0.7 bar to P=0.3 bar significantly reduced the velocity, as described above, and thus splashing, as shown.

### Experiment 5

Primer from an ink chamber in a inkjet printhead was jetted onto a ceramic body having a porosity of 30% and the results depicted in images (a)-(e) of FIG. 11 for an ink chamber pressure of 0.8 bar. Images (f)-(k) of FIG. 11 show the splashing resulting from the same printhead also at 0.8 bar ejecting methyl ethyl ketone only instead of primer (i.e., not including any pigment, binder, thickener, or other ingredients). The primer (images (a)-(e) of FIG. 11) had a surface tension of about 25.8 mN/m and viscosity of 2.55 mPa·s, while the methyl ethyl ketone (images (f)-(k) of FIG. 11) had a surface tension of about 17 mN/m and a viscosity of about 0.43 mPa·s. Despite the modest difference in surface tension and more significant difference in viscosity, FIG. 11 shows that the tested primer and methyl ethyl ketone exhibited similar splashing behavior.

Images (l)-(n) in FIG. 11 show the splashing resulting from the primer (the same as in images (a)-(e) of FIG. 11) jetted at reduced pressure P=0.3 bar. Very little splashing of the primer is observed in images (l)-(n) compared with images (a)-(e) and (f)-(k). Thus, FIG. 11 shows that lowering the ink chamber pressure (e.g., from 0.8 bar to 0.3 bar) reduces the amount of splashing of the primer.

### Experiment 6

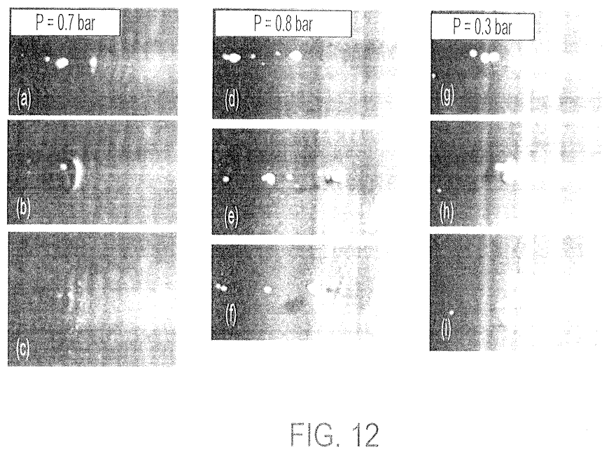

Materials from an ink chamber in a inkjet printhead were jetted onto a ceramic body having a porosity of approximately 60%. Images (a)-(c) in FIG. 12 show the results for jetting the primer at an ink chamber pressure of 0.7 bar. Images (d)-(f) show the results for jetting methyl ethyl ketone only at an ink chamber pressure of 0.7 bar. Similar to the results of FIG. 11, the splashing behavior of the primer generally resembled that of the methyl ethyl ketone only.

Images (g)-(i) of FIG. 12 show the results for jetting the primer at a reduced pressure P=0.3 bar. Similar to the images (l)-(n) in FIG. 11, very little splashing of the primer is observed in images (g)-(i) of FIG. 12 compared with images (a)-(c) and (d)-(f) of FIG. 12. Because the ceramic body used for Experiment 6 was more porous than the ceramic body used for Experiment 5, more vigorous wicking of the jetted materials occurred, but lowering the ink chamber pressure to 0.3 bar further reduced the amount of splashing of the jetted primer.

### Experiment 7

Experiments 5 and 6 compared the behavior of the primer to that of just the solvent. As noted with respect to these Experiments, despite a difference in viscosities, the splashing behavior was similar. It was determined to compare the primer to other materials having a significantly different surface tension but similar viscosity to that of the primer used in the Experiments. For example, a mixture of 30% glycerol in water has a viscosity of about 2.6 mPa·s (substantially similar to that of the primer tested in Experiments 5-6) and a surface tension of about 72 mN/m (almost three times greater than that of the primer used in Experiments 5-6). Such a water/glycerol mixture will produce very little splashing at similar velocities to those used in Experiments 5 and 6. As a result, other materials were considered to replace MEK as a solvent, particularly those having substantially greater values of surface tensions, e.g., having a value least about 50% greater than that of MEK, which is at least about 25 mN/m. Pentyl propionate is one example of a solvent material, having a surface tension of about 26 mN/m. Once combined with a pigment, a binder, and/or other ingredients to form a primer mixture, the corresponding surface tension of the resulting primer is also increased. In some embodiments, the primer has a surface tension of preferably at least about 40 mN/m and more preferably at least about 50 mN/m.

The embodiments disclosed herein thereby provide inkjet printing systems, components, primer compositions, and/or associated methods of marking honeycomb bodies that facilitate the marking of ceramic bodies such as by reducing overspray to improve print quality and reduce the amount of ink wasted to overspraying.

Those skilled in the art will appreciate that other modifications and variations can be made without departing from the spirit or scope of the invention. Since modifications, combinations, sub-combinations, and variations of the disclosed embodiments incorporating the spirit and substance of the invention may occur to persons skilled in the art, the invention should be construed to include everything within the scope of the appended claims and their equivalents.

1. An inkjet printhead for applying primer to a target area on an outer surface of a ceramic body comprising:
an ink chamber comprising the primer therein, the primer comprising a pigment, a binder, and a solvent, and comprising a surface tension of at least about 40 mN/m; and
a spray nozzle connected to the ink chamber, the spray nozzle comprising an exit opening that comprises an area of less than about 20,000 square microns, the spray nozzle configured to eject droplets of the primer from the exit opening at an average exit velocity of less than about 4 m/s.

2. The inkjet printhead of claim 1, wherein the pressure of the inkjet chamber is less than about 0.5 bar.

3. The inkjet printhead of claim 1, wherein the pressure of the inkjet chamber is less than about 0.4 bar.

4. The inkjet printhead of claim 1, wherein the area of the exit opening of the spray nozzle is less than about 10,000 square microns.

5. The inkjet printhead of claim 1, wherein the exit area is circular or slot shaped.

6. The inkjet printhead of claim 1, wherein the primer comprises a TiO₂ pigment, a binder, and a solvent.

7. The inkjet printhead of claim 1, wherein the primer has a surface tension of at least about 50 mN/m.

8. The inkjet printhead of claim 1, wherein the solvent comprises at least about 50 wt % pentyl propionate.

9. A system comprising the inkjet printhead and the ceramic body of claim 1.

10. The system of claim 9, further comprising a conveyor configured to move the ceramic body relative to the inkjet printhead.

11. The system of claim 9, wherein the ceramic body is a fired ceramic body.

12. The system of claim 9, wherein the ceramic body is a green body.

13. A method of marking an outer skin of a ceramic body, comprising:
ejecting primer from an ink chamber of an inkjet printhead via an exit opening of a nozzle at an exit velocity of less than about 4 m/s; and
forming a layer of primer in a target area on an outer surface of the ceramic body by spraying primer from an ink chamber and through an exit opening of a nozzle of an inkjet printhead at an exit velocity of less than about 4 m/s, wherein the primer has a surface tension of at least about 40 mN/m when ejected from the nozzle.

14. The method of claim 13 wherein the pressure of the inkjet chamber is less than about 0.5 bar.

15. The method of claim 13 wherein the pressure of the ink chamber is less than about 0.4 bar.

16. The method of claim 13 wherein the exit area of the spray nozzle is less than about 20,000 square microns.

17. The method of claim 13 wherein the exit opening is circular or slot shaped.

18. The method of claim 13 wherein the primer comprises a TiO₂ pigment, silicone resins, and a solvent.

19. The method of claim 13 wherein the solvent comprises at least about 50 wt % pentyl propionate.

20. The method of claim 13 additionally comprising laser marking a code on the primer layer.
